(19) United States
(12) Patent Application Publication
(10) Pub. No.: US 2014/0044953 A1
(43) Pub. Date: Feb. 13, 2014

(54) ADHESIVE LAYER FOR OPTICAL FILM AND METHOD FOR PRODUCING SAME, ADHESIVE OPTICAL FILM AND METHOD FOR PRODUCING SAME, IMAGE DISPLAY DEVICE, AND COATING LIQUID SUPPLY DEVICE

(71) Applicants: Naoki Tomoguchi, Ibaraki-shi (JP); Takaaki Ishii, Ibaraki-shi (JP); Yousuke Makihata, Ibaraki-shi (JP); Tomoaki Masuda, Ibaraki-shi (JP); Sonjin Ryu, Ibaraki-shi (JP); Tsutomu Morohoshi, Ibaraki-shi (JP)

(72) Inventors: Naoki Tomoguchi, Ibaraki-shi (JP); Takaaki Ishii, Ibaraki-shi (JP); Yousuke Makihata, Ibaraki-shi (JP); Tomoaki Masuda, Ibaraki-shi (JP); Sonjin Ryu, Ibaraki-shi (JP); Tsutomu Morohoshi, Ibaraki-shi (JP)

(73) Assignee: NITTO DENKO CORPORATION, Ibaraki-shi, Osaka (JP)

(21) Appl. No.: 14/112,099

(22) PCT Filed: Apr. 20, 2012
(86) PCT No.: PCT/JP2012/060666

§ 371 Date: Oct. 16, 2013

(30) Foreign Application Priority Data
Apr. 25, 2011 (JP) 2011-097249

(51) Int. Cl. C09J 9/00; C09J 7/02

(52) U.S. Cl. CPC C09J 9/00; C09J 7/0207
USPC 428/317.3; 427/208.4; 427/162; 118/600; 428/343; 428/354

(57) ABSTRACT

A method for manufacturing a pressure-sensitive adhesive layer for use on an optical film, the method includes a filtration step including filtering a pressure-sensitive adhesive coating liquid under a differential pressure of more than 0 kPa and not more than 150 kPa using a depth type filter having a filtration accuracy of 1 to 20 μm. The pressure-sensitive adhesive coating liquid contains an aqueous dispersion-type pressure-sensitive adhesive; and an application and drying step including applying the filtered pressure-sensitive adhesive coating liquid and then drying the coating liquid.

### TECHNICAL FIELD

The present invention relates to a pressure-sensitive adhesive layer with a reduced number of appearance defects caused by air bubbles and/or contaminants for use on an optical film and to a method for manufacturing such a pressure-sensitive adhesive layer. The present invention also relates to a pressure-sensitive adhesive-type optical film including an optical film and a pressure-sensitive adhesive layer placed on at least one side of the optical film, wherein the pressure-sensitive adhesive layer contains a reduced number of appearance defects, and relates to a method for manufacturing such a pressure-sensitive adhesive-type optical film. Examples of such a pressure-sensitive adhesive-type optical film include a polarizing plate, a retardation plate, an optical compensation film, a brightness enhancement film, a surface treatment film such as an anti-reflection film, and a laminate of any combination thereof, each of which has a pressure-sensitive adhesive layer placed on at least one side. The present invention further relates to an image display device produced with at least one piece of the pressure-sensitive adhesive-type optical film, and to a coating liquid supplying apparatus for supplying a pressure-sensitive adhesive coating liquid as a raw material for a pressure-sensitive adhesive layer for forming the pressure-sensitive adhesive-type optical film.

### BACKGROUND ART

Liquid crystal display devices, organic EL display devices, etc. have an image-forming mechanism including polarizing elements as essential components. For example, therefore, in a liquid crystal display device, polarizing elements are essentially arranged on both sides of a liquid crystal cell, and generally, polarizing plates are attached as the polarizing elements. Besides polarizing plates, various optical elements for improving display quality have become used in display panels such as liquid crystal panels and organic EL panels. Front face plates are also used to protect image display devices such as liquid crystal display devices, organic EL display devices, CRTs, and PDPs or to provide a high-grade appearance or a differentiated design. Examples of parts used in image display devices such as liquid crystal display devices and organic EL display devices or parts used together with image display devices, such as front face plates, include retardation plates for preventing discoloration, viewing angle-widening films for improving the viewing angle of liquid crystal displays, brightness enhancement films for increasing the contrast of displays, and surface treatment films such as hard-coat films for use in imparting scratch resistance to surfaces, anti-glare treatment films for preventing glare on image display devices, and anti-reflection films such as anti-reflective films and low-reflective films. These films are generically called optical films.

When such optical films are bonded to a display panel such as a liquid crystal cell or an organic EL panel or bonded to a front face plate, a pressure-sensitive adhesive is generally used. In the process of bonding an optical film to a display panel such as a liquid crystal cell or an organic EL panel or to a front face plate or bonding optical films together, a pressure-sensitive adhesive is generally used to bond the materials together so that optical loss can be reduced. In such a case, a pressure-sensitive adhesive layer-carrying optical film including an optical film and a pressure-sensitive adhesive layer previously formed on one side of the optical film is generally used, because it has some advantages such as no need for a drying process to fix the optical film.

Pressure-sensitive adhesive-type optical films are used in image display devices designed to be viewed directly. Thus, pressure-sensitive adhesive layers for such optical films also undergo very strict quality control for appearance defects (streaky defects and point defects) caused by contaminants or air bubbles. In general, therefore, a pressure-sensitive adhesive coating liquid as a raw material for pressure-sensitive adhesive layers is subjected to a vacuum degassing treatment or a centrifugation treatment and a filtration treatment as needed before applied to optical films. However, when the pressure-sensitive adhesive coating liquid has high viscosity or when air bubbles of very small sizes are removed, air bubbles are often insufficiently removed while much time and labor are necessary in an attempt to remove air bubbles from the coating liquid by a vacuum degassing treatment or a centrifugation treatment.

Patent Document 1 listed below discloses a method for manufacturing an optical film, which includes at least the steps of: filtering a coating liquid containing a solvent and an active radiation-curable monomer component (what is called a “solvent-based coating liquid”) by means of a depth type filter having a polyolefin filter medium, for the purpose of removing a very small amount of a shedding defect-inducing component such as polydimethylsiloxane; and applying the filtered coating liquid onto a film substrate to form a coating layer, wherein in the coating layer, the number of defects of 100 μm or more not containing any nucleus-forming contaminants is 1.0 or more per 1 m² film. In general, when a solvent-based coating liquid with low viscosity is used, the method disclosed in this patent document is useful as means to remove contaminants and air bubbles, which can cause defects of 100 μm or more.

### PRIOR ART DOCUMENT

### Patent Document

Patent Document 1: Japanese Patent No. 4542920

### SUMMARY OF THE INVENTION

### Problems to be Solved by the Invention

As a result of earnest study, however, the present inventors have found that when an aqueous dispersion-type pressure-sensitive adhesive such as an emulsion solution which can easily trap air bubbles is used or when a pressure-sensitive adhesive coating liquid having viscosity higher than that of a solvent-based coating liquid is used, the method disclosed in the patent document is poor in efficiency of removal of air bubbles and/or contaminants.

The present invention has been made in view of the above circumstances, and an object of the present invention is to provide a pressure-sensitive adhesive layer with a reduced number of appearance defects for use on an optical film, in which such a reduced number of appearance defects result from effective removal of air bubbles and/or contaminants from a pressure-sensitive adhesive coating liquid as a raw material for the pressure-sensitive adhesive layer, to provide a method for manufacturing such a pressure-sensitive adhesive layer, to provide a pressure-sensitive adhesive-type optical film made of a laminate including such a pressure-sensitive adhesive layer used on an optical film, to provide a method for manufacturing such a pressure-sensitive adhesive-type optical film, to provide an image display device, and to provide a pressure-sensitive adhesive coating liquid-supplying apparatus for use in forming such a pressure-sensitive adhesive layer.

### Means for Solving the Problems

As a result of earnest study to solve the above problems, the present inventors have found that (i) a pressure-sensitive adhesive coating liquid composed mainly of an aqueous dispersion-type pressure-sensitive adhesive has a unique problem which does not occur with a solvent-based coating liquid, specifically, a problem in that the pressure-sensitive adhesive coating liquid composed mainly of an aqueous dispersion-type pressure-sensitive adhesive can easily trap air bubbles and can easily contain fine air bubbles, specifically, air bubbles of less than 100 μm, (ii) when a pressure-sensitive adhesive coating liquid having viscosity higher than that of the solvent-based coating liquid is filtered, a high differential pressure can cause air bubbles and/or contaminants to be easily deformed and to have a tendency to pass through a filter during filtration, and (iii) when a filter has too high or too low a filtration accuracy, fine air bubbles and/or contaminants cannot be reliably removed, and there is an optimal range of filtration accuracy. The present invention has been accomplished as a result of the study mentioned above and will achieve the object by means of the features described below.

Specifically, the present invention is directed to a method for manufacturing a pressure-sensitive adhesive layer for use on an optical film, the method including: a filtration step including filtering a pressure-sensitive adhesive coating liquid under a differential pressure of 150 kPa or less using a depth type filter having a filtration accuracy of 1 to 20 μm, wherein the pressure-sensitive adhesive coating liquid contains an aqueous dispersion-type pressure-sensitive adhesive; and an application and drying step including applying the filtered pressure-sensitive adhesive coating liquid and then drying the coating liquid. In the method for manufacturing a pressure-sensitive adhesive layer for use on an optical film, the depth type filter preferably has a filtration accuracy gradient.

The present invention is also directed to a pressure-sensitive adhesive layer for use on an optical film. Such a pressure-sensitive adhesive layer is manufactured by any of the manufacturing methods stated above and preferably contains no air bubble and/or contaminant specifically with a maximum length of more than 100 μm and preferably has a surface in which the number of air bubbles and/or contaminants with a maximum length of 20 μm or more is 10 per m² or less. In the present invention, appearance defects in the pressure-sensitive adhesive layer may be caused only by air bubbles or contaminants in the pressure-sensitive adhesive coating liquid or caused by both air bubbles and contaminants in the pressure-sensitive adhesive coating liquid.

The present invention is also directed to a method for manufacturing a pressure-sensitive adhesive-type optical film including an optical film and a pressure-sensitive adhesive layer placed on at least one side of the optical film, the method including the step of forming the pressure-sensitive adhesive layer, which includes a filtration step including filtering a pressure-sensitive adhesive coating liquid as a raw material for the pressure-sensitive adhesive layer under a differential pressure of more than 0 kPa and not more than 150 kPa using a depth type filter, wherein the pressure-sensitive adhesive coating liquid contains an aqueous dispersion-type pressure-sensitive adhesive, and the depth type filter has a filtration accuracy of 1 to 20 μm.

In the method for manufacturing a pressure-sensitive adhesive-type optical film, the depth type filter preferably has a filtration accuracy gradient.

The method for manufacturing a pressure-sensitive adhesive-type optical film preferably further includes an application and drying step including applying the pressure-sensitive adhesive coating liquid to a flexible support (web) after the filtration step and drying the coating liquid to form a pressure-sensitive adhesive layer-bearing flexible support (web); and a transfer step including transferring the pressure-sensitive adhesive layer from the pressure-sensitive adhesive layer-bearing flexible support (web) onto the optical film.

The method for manufacturing a pressure-sensitive adhesive-type optical film preferably further includes an application and drying step including applying the pressure-sensitive adhesive coating liquid onto the optical film after the filtration step and then drying the coating liquid.

The present invention is also directed to a pressure-sensitive adhesive-type optical film manufactured by any of the manufacturing methods stated above. The present invention is also directed to an image display device produced with at least one piece of the pressure-sensitive adhesive-type optical film stated above.

The present invention is also directed to a coating liquid supplying apparatus for supplying a pressure-sensitive adhesive coating liquid as a raw material for a pressure-sensitive adhesive layer for forming a pressure-sensitive adhesive-type optical film, the apparatus including at least a pump for feeding the pressure-sensitive adhesive coating liquid, a filtration unit for removing air bubbles and/or contaminants from the pressure-sensitive adhesive coating liquid, and a transport unit for transporting the pressure-sensitive adhesive coating liquid, wherein the filtration unit includes a depth type filter having a filtration accuracy of 1 to 20 μm and has the function of filtering the coating liquid under a differential pressure of more than 0 kPa and not more than 150 kPa. In the coating liquid supplying apparatus, the depth type filter preferably has a filtration accuracy gradient.

### Effect of the Invention

The method of the present invention for manufacturing a pressure-sensitive adhesive layer for use on an optical film includes the step of filtering a pressure-sensitive adhesive coating liquid containing an aqueous dispersion-type pressure-sensitive adhesive. An aqueous dispersion-type pressure-sensitive adhesive can easily contain fine air bubbles, specifically, air bubbles of less than 100 μm because as compared to a solvent-type coating liquid generally having low viscosity, it can easily trap air bubbles and has relatively high viscosity. However, the method of the present invention for manufacturing a pressure-sensitive adhesive layer for use on an optical film can reliably and efficiently remove even fine air bubbles and/or contaminants, specifically, air bubbles and/or contaminants of less than 100 μm, because the method includes the step of filtering a pressure-sensitive adhesive coating liquid as a raw material for a pressure-sensitive adhesive layer under a differential pressure of more than 0 kPa and not more than 150 kPa using a depth type filter having a filtration accuracy of 1 to 20 μm. The depth type filter to be used may have a filtration accuracy gradient in such a manner that the filtration accuracy increases toward the downstream side. When such a depth type filter is used, larger air bubbles and/or contaminants can be captured on the upstream side, and smaller air bubbles and/or contaminants can be captured as they proceed downstream. This makes it possible to extend the life of the filter as well as to increase the efficiency of removal of air bubbles and/or contaminants. The method of the present invention for manufacturing a pressure-sensitive adhesive layer for use on an optical film can remove, at high efficiency, air bubbles and/or contaminants from a pressure-sensitive adhesive coating liquid with a viscosity of 5 to 50,000 mPa·s. Thus, the method of the present invention is particularly useful when a pressure-sensitive adhesive coating liquid with such a viscosity is used as a raw material. The method of the present invention for manufacturing a pressure-sensitive adhesive layer for use on an optical film is also more convenient than other degassing methods (such as a vacuum degassing treatment and a centrifugation treatment) because the depth filter can be installed during the manufacturing process, specifically, during the step of applying the pressure-sensitive adhesive coating liquid and the method has little effect on the properties of the pressure-sensitive adhesive coating liquid.

The method of the present invention for manufacturing a pressure-sensitive adhesive layer for use on an optical film makes it possible to manufacture a pressure-sensitive adhesive layer with an extremely reduced number of appearance defects, specifically, a pressure-sensitive adhesive layer containing no air bubble and/or contaminant with a maximum length of more than 100 μm and having a surface in which the number of air bubbles and/or contaminants with a maximum length of 20 μm or more is 10 per m² or less. Such a pressure-sensitive adhesive layer is a suitable member for use on an optical film.

The method of the present invention for manufacturing a pressure-sensitive adhesive-type optical film includes the step of filtering a pressure-sensitive adhesive coating liquid containing an aqueous dispersion-type pressure-sensitive adhesive. An aqueous dispersion-type pressure-sensitive adhesive can easily contain fine air bubbles, specifically, air bubbles of less than 100 μm because as compared to a solvent-type coating liquid generally having low viscosity, it can easily trap air bubbles and has relatively high viscosity. However, the method of the present invention for manufacturing a pressure-sensitive adhesive-type optical film can reliably and efficiently remove even fine air bubbles and/or contaminants, specifically, air bubbles and/or contaminants of less than 100 μm, because the method includes the step of filtering a pressure-sensitive adhesive coating liquid as a raw material for a pressure-sensitive adhesive layer under a differential pressure of more than 0 kPa and not more than 150 kPa using a depth type filter having a filtration accuracy of 1 to 20 μm. The depth type filter to be used may have a filtration accuracy gradient in such a manner that the filtration accuracy increases toward the downstream side. When such a depth type filter is used, larger air bubbles and/or contaminants can be captured on the upstream side, and smaller air bubbles and/or contaminants can be captured as they proceed downstream. This makes it possible to extend the life of the filter as well as to increase the efficiency of removal of air bubbles and/or contaminants. The method of the present invention for manufacturing a pressure-sensitive adhesive-type optical film can remove, at high efficiency, air bubbles and/or contaminants from a pressure-sensitive adhesive coating liquid with a viscosity of 5 to 50,000 mPa·s. Thus, the method of the present invention is particularly useful when a pressure-sensitive adhesive coating liquid with such a viscosity is used as a raw material. The method of the present invention for manufacturing a pressure-sensitive adhesive-type optical film is also more convenient than other degassing methods (such as a vacuum degassing treatment and a centrifugation treatment) because the depth filter can be installed during the manufacturing process, specifically, during the step of applying the pressure-sensitive adhesive coating liquid and the method has little effect on the properties of the pressure-sensitive adhesive coating liquid.

The pressure-sensitive adhesive-type optical film made of a laminate having a pressure-sensitive adhesive layer may be manufactured by a process further including the step of applying the pressure-sensitive adhesive coating liquid onto the optical film after the filtration step and then drying the coating liquid. Alternatively, the pressure-sensitive adhesive-type optical film made of a laminate having a pressure-sensitive adhesive layer may be manufactured by a process further including the step of applying the pressure-sensitive adhesive coating liquid to a flexible support (web) after the filtration step and drying the coating liquid to form a pressure-sensitive adhesive layer-bearing flexible support (web) and the step of transferring the pressure-sensitive adhesive layer from the pressure-sensitive adhesive layer-bearing flexible support (web) onto the optical film. In the latter case, the optical film can be prevented from being heated in a step of drying by heating, so that the optical properties of the optical film can be kept intact while the pressure-sensitive adhesive-type optical film is manufactured.

The method of the present invention for manufacturing a pressure-sensitive adhesive-type optical film makes it possible to manufacture a pressure-sensitive adhesive-type optical film having a pressure-sensitive adhesive layer with a reduced number of appearance defects. Thus, an image display device produced with at least one piece of such a pressure-sensitive adhesive-type optical film also has a reduced number of appearance defects.

The coating liquid supplying apparatus of the present invention can reliably and efficiently remove appearance defect-inducing air bubbles and/or contaminants from a coating liquid. Thus, the coating liquid supplying apparatus is suitable for use in a pressure-sensitive adhesive-type optical film manufacturing apparatus.

### MODE FOR CARRYING OUT THE INVENTION

The method of the present invention for manufacturing an pressure-sensitive adhesive layer for use on an optical film includes a filtration step including filtering a pressure-sensitive adhesive coating liquid under a differential pressure of more than 0 kPa and not more than 150 kPa using a depth type filter having a filtration accuracy of 1 to 20 μm, wherein the pressure-sensitive adhesive coating liquid contains an aqueous dispersion-type pressure-sensitive adhesive, and an application and drying step including applying the filtered pressure-sensitive adhesive coating liquid and then drying the coating liquid.

The pressure-sensitive adhesive coating liquid contains an aqueous dispersion-type pressure-sensitive adhesive. In addition to the aqueous dispersion-type pressure-sensitive adhesive, if necessary, the pressure-sensitive adhesive coating liquid may contain any of various viscosity modifiers, release modifiers, tackifiers, plasticizers, softeners, glass fibers, glass beads, metal powders, fillers made of other inorganic powders, pigments, colorants (such as pigments and dyes), pH regulators (acids or bases), antioxidants, ultraviolet absorbers, silane coupling agents, and the like.

The aqueous dispersion-type pressure-sensitive adhesive is an aqueous dispersion containing at least a base polymer dispersed in water. Usually, the aqueous dispersion to be used contains a base polymer dispersed in the presence of a surfactant. However, an aqueous dispersion containing a self-dispersible base polymer dispersed by itself in water may also be used.

The base polymer in the aqueous dispersion may be a product obtained by emulsion polymerization of a monomer or monomers in the presence of an emulsifier or a product obtained by dispersion polymerization of a monomer or monomers in the presence of a surfactant.

The aqueous dispersion may also be produced by dispersing and emulsifying a base polymer in water in the presence of an emulsifier, in which the base polymer has been produced separately. The emulsifying method may be a method including uniformly dispersing and emulsifying a polymer and an emulsifier, which may or may not have previously been melted by heating, with water using a mixer, such as a pressure kneader, a colloid mill, or a high-speed stirring shaft, under high shearing, and then cooling the mixture in such a manner that the dispersed particles do not fuse or aggregate, so that a desired aqueous dispersion is obtained (high-pressure emulsification method); or a method including previously dissolving a polymer in an organic solvent such as benzene, toluene, or ethyl acetate, then adding the emulsifier and water to the solution, uniformly dispersing and emulsifying the mixture typically using a high-speed homogenizer under high shearing, and then removing the organic solvent by a heat treatment under reduced pressure or other methods to form a desired aqueous dispersion (solvent solution method).

The aqueous dispersion-type pressure-sensitive adhesive to be used may be of any type such as a rubber-based pressure-sensitive adhesive, an acryl-based pressure-sensitive adhesive, a silicone-based pressure-sensitive adhesive, a polyurethane-based pressure-sensitive adhesive, a vinyl alkyl ether-based pressure-sensitive adhesive, a polyvinyl alcohol-based pressure-sensitive adhesive, a polyvinylpyrrolidone-based pressure-sensitive adhesive, a polyacrylamide-based pressure-sensitive adhesive, a cellulose-based pressure-sensitive adhesive, a polyester-based pressure-sensitive adhesive, or a fluoride-based pressure-sensitive adhesive. The pressure-sensitive adhesive base polymer or the dispersing means is selected depending on the type of the pressure-sensitive adhesive.

Among the above pressure-sensitive adhesives, an aqueous dispersion-type acryl-based pressure-sensitive adhesive is preferably used in the present invention because it has a high level of optical transparency and weather resistance or heat resistance and exhibits appropriate wettability and pressure-sensitive adhesive properties such as appropriate cohesiveness and tackiness.

An aqueous dispersion-type acrylic pressure-sensitive adhesive includes a (meth)acryl-based polymer as a base polymer. For example, such a (meth)acryl-based polymer can be obtained in the form of a copolymer emulsion by emulsion polymerization of monomers, which include alkyl (meth)acrylate as a principal monomer, in the presence of an emulsifier and a radical polymerization initiator. The term “alkyl (meth)acrylate” refers to alkyl acrylate and/or alkyl methacrylate, and “(meth)” is used in the same meaning in the description.

For example, the alkyl (meth)acrylate used to form the main skeleton of the (meth)acryl-based polymer may have a straight or branched chain alkyl group of 1 to 20 carbon atoms. For example, the alkyl group may be methyl, ethyl, propyl, isopropyl, n-butyl, isobutyl, sec-butyl, tert-butyl, pentyl, neopentyl, isoamyl, hexyl, heptyl, 2-ethylhexyl, isooctyl, nonyl, isononyl, decyl, isodecyl, dodecyl, tridecyl, tetradecyl, pentadecyl, hexadecyl, heptadecyl, octadecyl, nonadecyl, or eicosyl. These may be used alone or in any combination. The average number of carbon atoms in such alkyl groups is preferably from 3 to 9. Particularly in the present invention, a monomer having a boiling point higher than that of water, such as butyl acrylate, is preferably used as the alkyl (meth)acrylate.

Besides the alkyl (meth)acrylate, one or more copolymerizable monomers having an unsaturated double bond-containing polymerizable functional group such as a (meth)acryloyl group or a vinyl group may be incorporated into the (meth)acryl-based polymer by copolymerization for purposes such as stabilization of the aqueous dispersion, improvement in the adhesion of the pressure-sensitive adhesive layer to the backing material such as an optical film, and improvement in the initial tackiness to adherends.

Examples of the copolymerizable monomer include, but are not limited to, carboxyl group-containing monomers such as (meth)acrylic acid, itaconic acid, maleic acid, fumaric acid, crotonic acid, carboxyethyl acrylate, and carboxypentyl acrylate; acid anhydride group-containing monomers such as maleic anhydride and itaconic anhydride; alicyclic hydrocarbon esters of (meth)acrylic acid, such as cyclohexyl (meth)acrylate, bornyl (meth)acrylate, and isobornyl (meth)acrylate; aryl (meth)acrylate such as phenyl (meth)acrylate; vinyl esters such as vinyl acetate and vinyl propionate; styrene monomers such as styrene and α-methylstyrene; epoxy group-containing monomers such as glycidyl (meth)acrylate and methylglycidyl (meth)acrylate; hydroxyl group-containing monomers such as 2-hydroxyethyl (meth)acrylate, 2-hydroxypropyl (meth)acrylate, and 4-hydroxybutyl (meth)acrylate; nitrogen atom-containing monomers such as (meth)acrylamide, N,N-dimethyl(meth)acrylamide, N,N-diethyl(meth)acrylamide, N-isopropyl(meth)acrylamide, N-butyl(meth)acrylamide, N-methylol(meth)acrylamide, N-methylolpropane(meth)acrylamide, (meth)acryloylmorpholine, aminoethyl (meth)acrylate, N,N-dimethylaminoethyl (meth)acrylate, and tert-butylaminoethyl (meth)acrylate; alkoxy group-containing monomers such as methoxyethyl (meth)acrylate and ethoxyethyl (meth)acrylate; cyano group-containing monomers such as acrylonitrile and methacrylonitrile; functional monomers such as 2-methacryloyloxyethyl isocyanate; olefin monomers such as ethylene, propylene, isoprene, butadiene, and isobutylene; vinyl ether monomers such as vinyl ether; halogen atom-containing monomers such as vinyl chloride; and other monomers including vinyl group-containing heterocyclic compounds such as N-vinylpyrrolidone, N-(1-methylvinyl)pyrrolidone, N-vinylpyridine, N-vinylpiperidone, N-vinylpyrimidine, N-vinylpiperazine, N-vinylpyrazine, N-vinylpyrrole, N-vinylimidazole, N-vinyloxazole, and N-vinylmorpholine, and N-vinylcarboxylic acid amides.

Examples of the copolymerizable monomer also include maleimide monomers such as N-cyclohexylmaleimide, N-isopropylmaleimide, N-laurylmaleimide, and N-phenylmaleimide; itaconimide monomers such as N-methylitaconimide, N-ethylitaconimide, N-butylitaconimide, N-octylitaconimide, N-2-ethylhexylitaconimide, N-cyclohexylitaconimide, and N-laurylitaconimide; succinimide monomers such as N-(meth)acryloyloxymethylenesuccinimide, N-(meth)acryloyl-6-oxyhexamethylenesuccinimide, and N-(meth)acryloyl-8-oxyoctamethylenesuccinimide; and sulfonic acid group-containing monomers such as styrenesulfonic acid, allylsulfonic acid, 2-(meth)acrylamido-2-methylpropanesulfonic acid, (meth)acrylamidopropanesulfonic acid, sulfopropyl (meth)acrylate, and (meth)acryloyloxynaphthalenesulfonic acid.

The copolymerizable monomer may also be a phosphate group-containing monomer. For example, the phosphate group-containing monomer may be a phosphate group-containing monomer represented by general formula (I) below or a salt thereof.

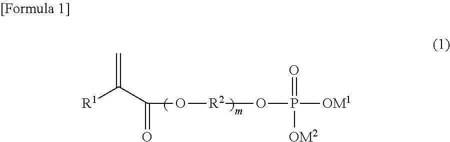

(In general formula (I), R¹ represents a hydrogen atom or a methyl group, R² represents an alkylene group of 1 to 4 carbon atoms, m represents an integer of 2 or more, and M¹ and M² each independently represent a hydrogen atom or a cation.)

In general formula (I), m is 2 or more, preferably 4 or more, and generally 40 or less, and m represents the degree of polymerization of the oxyalkylene groups. For example, the polyoxyalkylene group may be a polyoxyethylene group or a polyoxypropylene group, and these polyoxyalkylene groups may include random, block, or graft units. The cation of the salt of the phosphate group is typically, but not limited to, an inorganic cation such as an alkali metal such as sodium or potassium or an alkaline-earth metal such as calcium or magnesium, or an organic cation such as a quaternary amine.

Examples of the copolymerizable monomer also include glycol acrylate monomers such as polyethylene glycol (meth)acrylate, polypropylene glycol (meth)acrylate, methoxyethylene glycol (meth)acrylate, and methoxypolypropylene glycol (meth)acrylate; and other monomers such as acrylic ester monomers containing a heterocyclic ring or a halogen atom, such as tetrahydrofurfuryl (meth)acrylate and fluoro(meth)acrylate.

The copolymerizable monomer may also be a silicone-modified unsaturated monomer. Silicone-modified unsaturated monomers include silicone-modified (meth)acrylate monomers and silicone-modified vinyl monomers. Examples of silicone-modified (meth)acrylate monomers include (meth)acryloyloxyalkyl-trialkoxysilanes such as (meth)acryloyloxymethyl-trimethoxysilane, (meth)acryloyloxymethyl-triethoxysilane, 2-(meth)acryloyloxyethyl-trimethoxysilane, 2-(meth)acryloyloxyethyl-triethoxysilane, 3-(meth)acryloyloxypropyl-trimethoxysilane, 3-(meth)acryloyloxypropyl-triethoxysilane, 3-(meth)acryloyloxypropyl-tripropoxysilane, 3-(meth)acryloyloxypropyl-triisopropoxysilane, and 3-(meth)acryloyloxypropyl-tributoxysilane; (meth)acryloyloxyalkyl-alkyldialkoxysilanes such as (meth)acryloyloxymethyl-methyldimethoxysilane, (meth)acryloyloxymethyl-methyldiethoxysilane, 2-(meth)acryloyloxyethyl-methyldimethoxysilane, 2-(meth)acryloyloxyethyl-methyldiethoxysilane, 3-(meth)acryloyloxypropyl-methyldimethoxysilane, 3-(meth)acryloyloxypropyl-methyldiethoxysilane, 3-(meth)acryloyloxypropyl-methyldipropoxysilane, 3-(meth)acryloyloxypropyl-methyldiisopropoxysilane, 3-(meth)acryloyloxypropyl-methyldibutoxysilane, 3-(meth)acryloyloxypropyl-ethyldimethoxysilane, 3-(meth)acryloyloxypropyl-ethyldiethoxysilane, 3-(meth)acryloyloxypropyl-ethyldipropoxysilane, 3-(meth)acryloyloxypropyl-ethyldiisopropoxysilane, 3-(meth)acryloyloxypropyl-ethyldibutoxysilane, 3-(meth)acryloyloxypropyl-propyldimethoxysilane, and 3-(meth)acryloyloxypropyl-propyldiethoxysilane; and (meth)acryloyloxyalkyl-dialkyl(mono)alkoxysilanes corresponding to these monomers. Examples of silicone-modified vinyl monomers include vinyltrialkoxysilanes such as vinyltrimethoxysilane, vinyltriethoxysilane, vinyltripropoxysilane, vinyltriisopropoxysilane, and vinyltributoxysilane, and vinylalkyldialkoxysilanes and vinyldialkylalkoxysilanes corresponding thereto; vinylalkyltrialkoxysilanes such as vinylmethyltrimethoxysilane, vinylmethyltriethoxysilane, β-vinylethyltrimethoxysilane, β-vinylethyltriethoxysilane, γ-vinylpropyltrimethoxysilane, γ-vinylpropyltriethoxysilane, γ-vinylpropyltripropoxysilane, γ-vinylpropyltriisopropoxysilane, and γ-vinylpropyltributoxysilane, and (vinylalkyl)alkyldialkoxysilanes and (vinylalkyl)dialkyl(mono)alkoxysilanes corresponding thereto.

A polyfunctional monomer may also be used as the copolymerizable monomer for a purpose such as control of the gel fraction of the aqueous dispersion-type pressure-sensitive adhesive. The polyfunctional monomer may be a compound having two or more unsaturated double bonds such as those in (meth)acryloyl groups or vinyl groups. Examples of such a polyfunctional monomer include (meth)acrylic esters of polyhydric alcohols, such as (mono or poly)alkylene glycol di(meth)acrylates including (mono or poly)ethylene glycol di(meth)acrylates such as ethylene glycol di(meth)acrylate, diethylene glycol di(meth)acrylate, triethylene glycol di(meth)acrylate, trimethylolpropane tri(meth)acrylate, and tetraethylene glycol di(meth)acrylate, (mono or poly)propylene glycol di(meth)acrylate such as propylene glycol di(meth)acrylate, neopentyl glycol di(meth)acrylate, 1,6-hexanediol di(meth)acrylate, pentaerythritol di(meth)acrylate, trimethylolpropane tri(meth)acrylate, pentaerythritol tri(meth)acrylate, and dipentaerythritol hexa(meth)acrylate; polyfunctional vinyl compounds such as divinylbenzene; and compounds having a reactive unsaturated double bond, such as allyl (meth)acrylate and vinyl (meth)acrylate. The polyfunctional monomer may also be a compound such as polyester (meth)acrylate, epoxy (meth)acrylate, or urethane (meth)acrylate having a polyester, epoxy, or urethane skeleton to which two or more unsaturated double bonds are added in the form of functional groups such as (meth)acryloyl groups or vinyl groups in the same manner as the above monomers.

Among these copolymerizable monomers, carboxyl group-containing monomers such as acrylic acid, phosphate group-containing monomers, or silicone-modified unsaturated monomers are preferably used to form a stable aqueous dispersion (emulsion or the like) or to ensure that the pressure-sensitive adhesive layer made from the aqueous dispersion can reliably adhere to an adherend, specifically, a glass panel.

The (meth)acryl-based polymer may include alkyl (meth)acrylate as amain component, and the content of the alkyl (meth)acrylate component may be 50% by weight or more, preferably 60% by weight or more, more preferably 70% by weight or more, based on the total amount of all monomer components. The upper limit of the content is typically, but not limited to, 100% by weight, preferably 99% by weight, more preferably 98% by weight. If the content of the alkyl (meth)acrylate component is less than 50% by weight, the adhesive properties of the pressure-sensitive adhesive layer, such as the adhering strength, may be degraded.

The content of the copolymerizable monomer is typically less than 50% by weight, preferably less than 40% by weight, more preferably less than 30% by weight, based on the total amount of all monomer components. The content of the copolymerizable monomer may be appropriately selected depending on the type of each copolymerizable monomer. Based on the total amount of all monomers, for example, the content of a carboxyl group-containing monomer as a copolymerizable monomer is preferably from 0.1 to 6% by weight, the content of a phosphate group-containing monomer is preferably from 0.5 to 5% by weight, and the content of a silicone-modified unsaturated monomer is preferably from 0.005 to 0.2% by weight.

The emulsion polymerization of the monomers may be performed by a conventional method including emulsifying the monomers in water and then subjecting the emulsion to emulsion polymerization. This method prepares an aqueous dispersion of a (meth)acryl-based polymer. In the emulsion polymerization, for example, the monomers are appropriately mixed in water with an emulsifier, a radical polymerization initiator, and an optional agent such as a chain transfer agent. More specifically, for example, a known emulsion polymerization method may be employed, such as a batch mixing method (batch polymerization method), a monomer dropping method, or a monomer emulsion dropping method. In a monomer dropping method or a monomer emulsion dropping method, continuous dropping or divided dropping is appropriately selected. These methods may be combined as needed. Reaction conditions and other conditions are appropriately selected, in which, for example, the polymerization temperature is from about 0 to about 150° C., and the polymerization time is from about 2 to about 15 hours.

The emulsifier may be any of various types of emulsifiers commonly used for emulsion polymerization. Examples of the emulsifier include anionic emulsifiers such as sodium lauryl sulfate, ammonium lauryl sulfate, sodium dodecylbenzenesulfonate, sodium polyoxyethylene lauryl sulfate, sodium polyoxyethylene alkyl ether sulfate, ammonium polyoxyethylene alkyl phenyl ether sulfate, sodium polyoxyethylene alkyl phenyl ether sulfate, and sodium polyoxyethylene alkyl sulfosuccinate; and nonionic emulsifiers such as polyoxyethylene alkyl ether, polyoxyethylene alkyl phenyl ether, polyoxyethylene fatty acid ester, and polyoxyethylene-polyoxypropylene block polymers. Other examples include radically-polymerizable emulsifiers prepared by introducing a radically-polymerizable functional group (radically reactive group) such as a propenyl group or an allyl ether group into the anionic surfactants or the nonionic surfactants. These emulsifiers may be appropriately used alone or in any combination. Among these emulsifiers, radically-polymerizable emulsifiers having a radically-polymerizable functional group are preferably used to form a stable aqueous dispersion (emulsion) or to form a durable pressure-sensitive adhesive layer.

For example, the content of the emulsifier may be from about 0.1 to about 5 parts by weight, preferably from 0.4 to 3 parts by weight, based on 100 parts by weight of the monomers including the alkyl (meth)acrylate as a principal monomer. When the emulsifier content is in this range, water resistance, pressure-sensitive adhesive properties, and stability such as polymerization stability or mechanical stability can be improved.

The radical polymerization initiator may be any known radical polymerization initiator commonly used for emulsion polymerization. Examples include azo initiators such as 2,2′-azobisisobutylonitrile, 2,2′-azobis(2-methylpropionamidine)disulfate, 2,2′-azobis(2-methylpropionamidine)dihydrochloride, 2,2′-azobis(2-amidinopropane)dihydrochloride, and 2,2′-azobis[2-(2-imidazoline-2-yl)propane]dihydrochloride; persulfate initiators such as potassium persulfate and ammonium persulfate; peroxide initiators such as benzoyl peroxide, tert-butyl hydroperoxide, and hydrogen peroxide; substituted ethane initiators such as phenyl-substituted ethane; and carbonyl initiators such as aromatic carbonyl compounds. Among these radical polymerization initiators, azo radical polymerization initiators are preferred because they can improve the transparency of the pressure-sensitive adhesive layer formed according to the present invention. These polymerization initiators may be appropriately used alone or in any combination. The content of the radical polymerization initiator, which may be selected as desired, is typically from about 0.02 to about 0.5 parts by weight, preferably from 0.08 to 0.3 parts by weight, based on 100 parts by weight of the monomers. If it is less than 0.02 parts by weight, the radical polymerization initiator may be less effective. If it is more than 0.5 parts by weight, the (meth)acryl-based polymer in the form of an aqueous dispersion may have a lower molecular weight, and the aqueous dispersion-type pressure-sensitive adhesive composition may have lower pressure-sensitive adhesive properties.

If necessary, a chain transfer agent may be used to control the molecular weight of the (meth)acryl-based polymer in the form of an aqueous dispersion. In general, the chain transfer agent may be one commonly used for emulsion polymerization. Examples include 1-dodecanthiol, mercaptoacetic acid, 2-mercaptoethanol, 2-ethylhexyl thioglycolate, 2,3-dimercapto-1-propanol, mercaptopropionic acid esters, and other mercaptans. These chain transfer agents may be appropriately used alone or in any combination. For example, the content of the chain transfer agent is from 0.001 to 0.3 parts by weight based on 100 parts by weight of the monomers.

Such emulsion polymerization makes it possible to prepare a (meth)acryl-based copolymer in the form of an aqueous dispersion (emulsion). The average particle size of such an aqueous dispersion-type (meth)acryl-based polymer is typically adjusted to 0.05 to 3 μm, preferably to 0.05 to 1 μm. If the average particle size is less than 0.05 μm, the viscosity of the aqueous dispersion-type pressure-sensitive adhesive may increase, and if it is more than 1 μm, adhesiveness between particles may decrease so that cohesive strength may decrease.

When the (meth)acryl-based polymer in the aqueous dispersion contains a carboxyl group-containing monomer component or the like as a copolymerized monomer component for maintaining the stability of the aqueous dispersion, the carboxyl group-containing monomer component or the like should preferably be neutralized. For example, the neutralization can be performed using ammonia, an alkali metal hydroxide, or the like.

In general, the aqueous dispersion-type (meth)acryl-based polymer according to the present invention preferably has a weight average molecular weight of 1,000,000 or more. In particular, the weight average molecular weight is preferably from 1,000,000 to 4,000,000 in view of heat resistance or moisture resistance. If the weight average molecular weight is less than 1,000,000, an undesired reduction in heat resistance or moisture resistance may occur. The pressure-sensitive adhesive obtained by the emulsion polymerization is preferred because the polymerization mechanism allows the adhesive to have a very high molecular weight. It should be noted that the pressure-sensitive adhesive obtained by the emulsion polymerization usually has a high gel content and cannot be subjected to GPC (gel permeation chromatography) measurement, which means that it is often difficult to identify the molecular weight by actual measurement.

In the present invention, the aqueous dispersion-type pressure-sensitive adhesive may contain a crosslinking agent in addition to the base polymer. When the aqueous dispersion-type pressure-sensitive adhesive is an aqueous dispersion-type acryl-based pressure-sensitive adhesive, a commonly used crosslinking agent such as an isocyanate crosslinking agent, an epoxy crosslinking agent, an oxazoline crosslinking agent, an aziridine crosslinking agent, a carbodiimide crosslinking agent, or a metal chelate crosslinking agent may be used therein. When a functional group-containing monomer is used, these crosslinking agents have the effect of reacting with the functional group incorporated in the polymer to form crosslinkage.

While the blending ratio of the crosslinking agent to the base polymer is not restricted, 10 parts by weight or less (solid basis) of the crosslinking agent is generally added to 100 parts by weight (solid basis) of the base polymer. The added amount of the crosslinking agent is preferably from 0.001 to 10 parts by weight, more preferably from 0.01 to 5 parts by weight.

The method of the present invention for manufacturing a pressure-sensitive adhesive layer for use on an optical film or the method of the present invention for manufacturing a pressure-sensitive adhesive-type optical film is preferably performed using a pressure-sensitive adhesive coating liquid with a viscosity of 5 to 50,000 mPa·s, more preferably using a pressure-sensitive adhesive coating liquid with a viscosity of 50 to 20,000 mPa·s, even more preferably using a pressure-sensitive adhesive coating liquid with a viscosity of 200 to 10,000 mPa·s, wherein the pressure-sensitive adhesive coating liquid contains an aqueous dispersion-type pressure-sensitive adhesive as a main component.

In the method of the present invention for manufacturing a pressure-sensitive adhesive layer for use on an optical film or in the method of the present invention for manufacturing a pressure-sensitive adhesive-type optical film, a depth type filter is used in the step of filtering a pressure-sensitive adhesive coating liquid, which is used as a raw material for the pressure-sensitive adhesive layer. Such a depth type filter has voids formed by a process including using polyolefin-based composite fibers, heat bondable polyester fibers, or other fibers and heat bonding the fibers at interlacing points. In general, pleated type filters, with which filtration is performed on the surface of the filter media, can suffer from clogging of the filter media when used repeatedly in a filtration process, or are more likely to allow air bubbles and/or contaminants to pass through the filters under a high differential pressure during filtration because air bubbles and/or contaminants on the filters can be easily deformed and reduced in size by the pressure. On the other hand, depth type filters, with which filtration is performed over the thickness of the filter media, are less likely to allow air bubbles and/or contaminants to pass through the filters because of the effect of their thickness. In the present invention, therefore, a depth filter is advantageously used in the step of filtering the pressure-sensitive adhesive coating liquid. Depth type filters are usually commercially available as cartridge type filters, and such commercially available depth type filters can also be advantageously used.

A depth type filter having a filtration accuracy of 1 to 20 μm is used in the method of the present invention for manufacturing a pressure-sensitive adhesive layer for use on an optical film or the method of the present invention for manufacturing a pressure-sensitive adhesive-type optical film. If a depth type filter having a filtration accuracy of more than 20 μm is used, the filtration pore size would be too large so that air bubbles and/or contaminants would easily pass through the filter and the efficiency of removal of air bubbles and/or contaminants of less than 100 μm would particularly decrease. On the other hand, if a depth type filter having a filtration accuracy of less than 1 μm is used, air bubbles and/or contaminants can be easily deformed as the differential pressure during filtration increases and the efficiency of removal of air bubbles and/or contaminants of less than 100 μm would particularly decrease with time. The depth type filter preferably has a filtration accuracy of 1 to 10 μm, more preferably 5 to 10 μm, for the purpose of increasing the efficiency of removal of air bubbles and/or contaminants and preventing the efficiency of removal of air bubbles and/or contaminants from decreasing over time with increasing differential pressure.

The differential pressure of the depth type filter is set at more than 0 kPa and not more than 150 kPa in the filtration step of the method of the present invention for manufacturing a pressure-sensitive adhesive layer for use on an optical film or the method of the present invention for manufacturing a pressure-sensitive adhesive-type optical film. If the differential pressure exceeds 150 kPa, air bubbles and/or contaminants would be deformed by the pressure so that they would easily pass through the filter and the efficiency of removal of air bubbles and/or contaminants of less than 100 μm would particularly decrease. In view of the efficiency of removal of air bubbles and/or contaminants, there is no specific lower limit for the differential pressure. At too low a differential pressure, however, it can take a long time to perform the filtration step. Thus, a certain lower limit higher than 0 kPa should preferably be set for the differential pressure. In view of productivity and the efficiency of removal of air bubbles and/or contaminants, the differential pressure of the depth type filter is preferably more than 0 kPa and not more than 130 kPa, more preferably more than 0 kPa and not more than 100 kPa. The depth type filter to be used may have a filtration accuracy gradient in such a manner that the filtration accuracy increases toward the downstream side. When such a depth type filter is used, larger air bubbles and/or contaminants can be captured on the upstream side, and smaller air bubbles and/or contaminants can be captured as they proceed downstream. This makes it possible to extend the life of the filter as well as to increase the efficiency of removal of air bubbles and/or contaminants.

The filtration step is preferably performed using a coating liquid supplying apparatus including at least a pump for feeding the pressure-sensitive adhesive coating liquid, a filtration unit for removing air bubbles and/or contaminants from the pressure-sensitive adhesive coating liquid, and a transport unit for transporting the pressure-sensitive adhesive coating liquid, wherein the filtration unit includes a depth type filter having a filtration accuracy of 1 to 20 μm and has the function of filtering the coating liquid under a differential pressure of more than 0 kPa and not more than 150 kPa. The depth type filter to be used preferably has a filtration accuracy gradient.

The method of the present invention for manufacturing a pressure-sensitive adhesive-type optical film includes the steps of: forming a pressure-sensitive adhesive layer using the filtered pressure-sensitive adhesive coating liquid as a raw material; and placing the pressure-sensitive adhesive layer on at least one side of an optical film. To further increase the adhesion between the optical film and the pressure-sensitive adhesive layer, the method of the present invention for manufacturing a pressure-sensitive adhesive-type optical film may further include the step of performing a corona treatment or a plasma treatment on the surface of the optical film where the pressure-sensitive adhesive layer is to be formed, before the step of placing the pressure-sensitive adhesive layer, or may further include the step of forming an anchor layer on the optical film, so that the anchor layer will be placed between the optical film and the pressure-sensitive adhesive layer.

The step of placing the pressure-sensitive adhesive layer on an optical film may be, but not limited to, the step of applying a pressure-sensitive adhesive solution to an optical film (or an anchor layer formed on the optical film or the corona-treated or plasma-treated surface of the optical film) and drying the pressure-sensitive adhesive solution; or the step of transferring a pressure-sensitive adhesive layer from a pressure-sensitive adhesive layer-bearing flexible support (web). The application method to be used may be roller coating such as reverse coating or gravure coating, spin coating, screen coating, fountain coating, dipping, or spraying. It should be noted that when a pressure-sensitive adhesive coating liquid containing an aqueous dispersion-type pressure-sensitive adhesive is used to form a pressure-sensitive adhesive layer for use on an optical film, a step of drying by heating at 80° C. or higher is necessary to remove water. When the pressure-sensitive adhesive coating liquid is applied directly onto the optical film, the step of drying by heating at 80° C. or higher may have an adverse effect on the optical properties of the optical film. In the present invention, therefore, a transfer method is preferred which includes applying the pressure-sensitive adhesive coating liquid to a flexible support (web), performing a drying step, and then transferring the resulting pressure-sensitive adhesive layer from the pressure-sensitive adhesive layer-bearing flexible support (web).

The pressure-sensitive adhesive layer constituting a laminate preferably has a thickness of 1 to 100 μm, more preferably 5 to 70 μm, even more preferably 10 to 50 μm. If the pressure-sensitive adhesive layer is too thin, a problem such as insufficient adhesion to the optical film or peeling off from a glass surface may easily occur. If it is too thick, a problem such as foaming of the pressure-sensitive adhesive layer may easily occur.

Examples of the material used to form the flexible support (web) include a paper sheet, a film of synthetic resin such as polyethylene, polypropylene, or polyethylene terephthalate, a rubber sheet, a paper sheet, a cloth, a nonwoven fabric, a net, a foamed sheet, a metal foil, a laminate of any combination thereof, and other appropriate thin materials. To increase the removability from the pressure-sensitive adhesive layer, if necessary, the surface of the flexible support (web) may have undergone a release treatment to reduce tackiness, such as a silicone treatment, a long-chain alkyl treatment, or a fluorine treatment.

For example, a polarizing plate may be used as the optical film in the method of the present invention for manufacturing a pressure-sensitive adhesive-type optical film. A polarizing plate including a polarizer and a transparent protective film or films provided on one or both sides of the polarizer is generally used.

Any of various polarizers may be used without restriction. For example, the polarizer may be a product produced by a process including adsorbing a dichroic material such as iodine or a dichroic dye to a hydrophilic polymer film such as a polyvinyl alcohol-based film, a partially-formalized polyvinyl alcohol-based film, or a partially-saponified, ethylene-vinyl acetate copolymer-based film and uniaxially stretching the film or may be a polyene-based oriented film such as a film of a dehydration product of polyvinyl alcohol or a dehydrochlorination product of polyvinyl chloride. In particular, a polarizer including a polyvinyl alcohol-based film and a dichroic material such as iodine is advantageous.

The thickness of the polarizer is generally, but not limited to, about 3 to 80 μm.

For example, a polarizer including a uniaxially-stretched polyvinyl alcohol-based film dyed with iodine may be produced by a process including immersing a polyvinyl alcohol film in an aqueous iodine solution to dye the film and stretching the film to 3 to 7 times the original length. If necessary, the polyvinyl alcohol-based film may be immersed in an aqueous solution of potassium iodide or the like optionally containing boric acid, zinc sulfate, zinc chloride, or the like. If necessary, the polyvinyl alcohol-based film may be further immersed in water for washing before it is dyed. If the polyvinyl alcohol-based film is washed with water, dirt and any anti-blocking agent can be cleaned from the surface of the polyvinyl alcohol-based film, and the polyvinyl alcohol-based film can also be allowed to swell so that unevenness such as uneven dyeing can be effectively prevented. The film may be stretched before, while, or after it is dyed with iodine. The film may also be stretched in an aqueous solution of boric acid, potassium iodide, or the like or in a water bath.

The material used to form the transparent protective film is typically thermoplastic resin with a high level of transparency, mechanical strength, thermal stability, water blocking properties, isotropy, etc. Specific examples of such thermoplastic resin include cellulose resin such as triacetylcellulose, polyester resin, polyethersulfone resin, polysulfone resin, polycarbonate resin, polyamide resin, polyimide resin, polyolefin resin, (meth)acrylic resin, cyclic polyolefin resin (norbornene resin), polyarylate resin, polystyrene resin, polyvinyl alcohol resin, and any blend thereof. The transparent protective film may be bonded to one side of the polarizer with an adhesive layer. In this case, thermosetting or ultraviolet-curable resin such as (meth)acrylic, urethane, acrylic urethane, epoxy, or silicone resin may be used to form a transparent protective film on the other side. The transparent protective film may contain any one or more appropriate additives. Examples of such an additive include an ultraviolet absorber, an antioxidant, a lubricant, a plasticizer, a release agent, an anti-discoloration agent, a flame retardant, a nucleating agent, an antistatic agent, a pigment, and a colorant. The content of the thermoplastic resin in the transparent protective film is preferably from 50 to 100% by weight, more preferably from 50 to 99% by weight, even more preferably from 60 to 98% by weight, still more preferably from 70 to 97% by weight. If the content of the thermoplastic resin in the transparent protective film is less than 50% by weight, high transparency and other properties inherent in the thermoplastic resin may be insufficiently exhibited.

The transparent protective film may also be the polymer film disclosed in JP-A-2001-343529 (WO01/37007), such as a film of a resin composition containing (A) a thermoplastic resin having a substituted and/or unsubstituted imide group in the side chain and (B) a thermoplastic resin having a substituted and/or unsubstituted phenyl and nitrile groups in the side chain. A specific example includes a film of a resin composition containing an alternating copolymer of isobutylene and N-methylmaleimide and an acrylonitrile-styrene copolymer. Films such as those produced by mixing and extruding the resin composition may be used. These films have a small retardation and a small photoelastic coefficient and thus can prevent polarizing plates from having defects such as strain-induced unevenness. They also have low water-vapor permeability and thus have high moisture resistance.

The thickness of the transparent protective film may be determined as appropriate. Its thickness is generally from about 1 to about 500 μm in view of strength, workability such as handleability, thin layer formability, or the like. In particular, its thickness is preferably from 1 to 300 μm, more preferably from 5 to 200 μm. The transparent protective film with a thickness of 5 to 150 μm is particularly preferred.

When transparent protective films are provided on both sides of the polarizer, protective films made of the same polymer material or different polymer materials may be used on the front and back sides.

In the present invention, at least one selected from cellulose resin, polycarbonate resin, cyclic polyolefin resin, and (meth)acrylic resin is preferably used to form the transparent protective film.

Cellulose resin is an ester of cellulose and a fatty acid. Specific examples of such a cellulose ester resin include triacetylcellulose, diacetyl cellulose, tripropionyl cellulose, dipropionyl cellulose, etc. Among them, triacetylcellulose is particularly preferred.

Triacetylcellulose has many commercially available sources and is advantageous in view of easy availability and cost. Examples of commercially available products of triacetylcellulose include UV-50, UV-80, SH-80, TD-80U, TD-TAC, and UZ-TAC (trade names) manufactured by Fujifilm Corporation, and KC series manufactured by KONICA MINOLTA. In general, these triacetylcellulose products have a thickness direction retardation (Rth) of about 60 nm or less, while having an in-plane retardation (Re) of almost zero.

For example, cellulose resin films with a relatively small thickness direction retardation can be obtained by processing any of the above cellulose resins. Examples of the processing method include a method that includes laminating a common cellulose-based film to a base film, such as a polyethylene terephthalate, polypropylene, or stainless steel film, coated with a solvent such as cyclopentanone or methyl ethyl ketone, drying the laminate by heating (for example, at 80 to 150° C. for about 3 to about 10 minutes), and then peeling off the base film; and a method that includes coating a common cellulose resin film with a solution of a norbornene resin, a (meth)acrylic resin or the like in a solvent such as cyclopentanone or methyl ethyl ketone, drying the coated film by heating (for example, at 80 to 150° C. for about 3 to about 10 minutes), and then peeling off the coating.

The cellulose resin film with a relatively small thickness direction retardation to be used may be a fatty acid cellulose resin film with a controlled degree of fat substitution. Triacetylcellulose for general use has a degree of acetic acid substitution of about 2.8. Preferably, however, the degree of acetic acid substitution should be controlled to be from 1.8 to 2.7 so that the Rth can be reduced. The Rth can also be controlled to be low by adding a plasticizer such as dibutyl phthalate, p-toluenesulfonanilide, or acetyl triethyl citrate to the fatty acid-substituted cellulose resin. The plasticizer is preferably added in an amount of 40 parts by weight or less, more preferably 1 to 20 parts by weight, even more preferably 1 to 15 parts by weight, to 100 parts by weight of the fatty acid cellulose resin.

For a specific example, the cyclic polyolefin resin is preferably a norbornene resin. Cyclic olefin resin is a generic name for resins produced by polymerization of cyclic olefin used as a polymerizable unit, and examples thereof include the resins disclosed in JP-A-01-240517, JP-A-03-14882, and JP-A-03-122137. Specific examples thereof include ring-opened (co)polymers of cyclic olefins, addition polymers of cyclic olefins, copolymers (typically random copolymers) of cyclic olefin and α-olefin such as ethylene or propylene, graft polymers produced by modification thereof with unsaturated carboxylic acids or derivatives thereof, and hydrides thereof. Specific examples of the cyclic olefin include norbornene monomers.

Cyclic polyolefin resins have various commercially available sources. Specific examples thereof include ZEONEX (trade name) and ZEONOR (trade name) series manufactured by ZEON CORPORATION, ARTON (trade name) series manufactured by JSR Corporation, TOPAS (trade name) series manufactured by Ticona, and APEL (trade name) series manufactured by Mitsui Chemicals, Inc.

The (meth)acrylic resin preferably has a glass transition temperature (Tg) of 115° C. or more, more preferably 120° C. or more, even more preferably 125° C. or more, still more preferably 130° C. or more. If the Tg is 115° C. or more, the resulting polarizing plate can have high durability. The upper limit to the Tg of the (meth)acrylic resin is preferably, but not limited to, 170° C. or less, in view of formability or the like. The (meth)acrylic resin can form a film with an in-plane retardation (Re) of almost zero and a thickness direction retardation (Rth) of almost zero.

Any appropriate (meth)acrylic resin may be used as long as the effects of the present invention are not impaired. Examples of such a (meth)acrylic resin include poly(meth)acrylate such as poly(methyl methacrylate), methyl methacrylate-(meth)acrylic acid copolymers, methyl methacrylate-(meth)acrylic ester copolymers, methyl methacrylate-acrylic ester-(meth)acrylic acid copolymers, methyl (meth)acrylate-styrene copolymers (such as MS resins), and alicyclic hydrocarbon group-containing polymers (such as methyl methacrylate-cyclohexyl methacrylate copolymers and methyl methacrylate-norbornyl (meth)acrylate copolymers). Poly(C1 to C6 alkyl (meth)acrylate) such as poly(methyl (meth)acrylate) is preferred. A methyl methacrylate-based resin composed mainly of a methyl methacrylate unit (50 to 100% by weight, preferably 70 to 100% by weight) is more preferred.

Specific examples of the (meth)acrylic resin include ACRYPET VH and ACRYPET VRL20A each manufactured by MITSUBISHI RAYON CO., LTD., and the (meth)acrylic resins disclosed in JP-A-2004-70296 including (meth)acrylic resins having a ring structure in their molecule and high-Tg (meth)acrylic resins obtained by intramolecular crosslinking or intramolecular cyclization reaction.

Lactone ring structure-containing (meth)acrylic resins may also be used as the (meth)acrylic resin. This is because they have high heat resistance and high transparency and also have high mechanical strength after biaxially stretched.

Examples of the lactone ring structure-containing (meth)acrylic reins include the lactone ring structure-containing (meth)acrylic reins disclosed in JP-A-2000-230016, JP-A-2001-151814, JP-A-2002-120326, JP-A-2002-254544, and JP-A-2005-146084.

The lactone ring structure-containing (meth)acrylic reins preferably have a ring-like structure represented by the following general formula (formula 2):

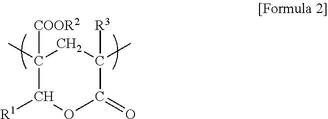

In the formula, R¹, R², and R³ each independently represent a hydrogen atom or an organic residue of 1 to 20 carbon atoms. The organic residue may contain an oxygen atom(s).

The content of the lactone ring structure represented by the general formula (formula 6) in the lactone ring structure-containing (meth)acrylic resin is preferably from 5 to 90% by weight, more preferably from 10 to 70% by weight, even more preferably from 10 to 60% by weight, still more preferably from 10 to 50% by weight. If the content of the lactone ring structure represented by the general formula (formula 6) in the lactone ring structure-containing (meth)acrylic resin is less than 5% by weight, the resin may have an insufficient level of heat resistance, solvent resistance, or surface hardness. If the content of the lactone ring structure represented by the general formula (formula 6) in the lactone ring structure-containing (meth)acrylic resin is more than 90% by weight, the resin may have low formability or workability.

The lactone ring structure-containing (meth)acrylic resin preferably has a mass average molecular weight (also referred to as “weight average molecular weight”) of 1,000 to 2,000,000, more preferably 5,000 to 1,000,000, even more preferably 10,000 to 500,000, still more preferably 50,000 to 500,000. Mass average molecular weights outside the above range are not preferred in view of formability or workability.

The lactone ring structure-containing (meth)acrylic resin preferably has a Tg of 115° C. or more, more preferably 120° C. or more, even more preferably 125° C. or more, still more preferably 130° C. or more. For example, if a transparent protective film made of such a resin with a Tg of 115° C. or more is incorporated into a polarizing plate, the polarizing plate will have high durability. The upper limit to the Tg of the lactone ring structure-containing (meth)acrylic resin is preferably, but not limited to, 170° C. or less, in view of formability or other properties.

An injection-molded product of the lactone ring structure-containing (meth)acrylic resin preferably has a total light transmittance as high as possible, preferably of 85% or more, more preferably of 88% or more, even more preferably of 90% or more, as measured by the method according to ASTM-D-1003. The total light transmittance is a measure of transparency, and a total light transmittance of less than 85% may mean lower transparency.

As the transparent protective film, usually, a film is used which has an in-plane retardation of less than 40 nm, and a thickness-direction retardation of less than 80 nm. The in-plane retardation Re is represented by Re=(nx−ny)×d. The thickness-direction retardation Rth is represented by Rth=(nx−nz)×d. The Nz coefficient is represented by Nz=(nx−nz)/(nx−ny). In these equations, nx, ny and nx represent the refractive index in the slow axis direction, that in the fast axis direction, and that in the thickness direction of the film, respectively, and d (nm) represents the thickness of the film. The slow axis direction is defined as the direction in the in-plane of the film in which the refractive index is the largest. It is preferred that the transparent protective film is colored as little as possible. It is preferred to use a protective film having a retardation value of −90 nm to +75 nm in the thickness direction. Using this film, the retardation value (Rth) of which is from −90 to +75 nm in the thickness direction, makes it possible to overcome substantially completely a coloration (optical coloration) of the polarizing plate caused by the transparent protective film. The retardation value in the thickness direction (Tth) is more preferably from −80 nm to +60 nm, in particular preferably from −70 nm to +45 nm.

Meanwhile, the transparent protective film used may be a retardation plate having an in-plane retardation of 40 nm or more and/or a thickness-direction retardation of 80 nm or more. The in-plane retardation and the thickness-direction retardation are usually controlled into the range of 40 to 200 nm and that of 80 to 300 nm, respectively. When a retardation plate is used as a transparent protective film, the whole can be made thin since this retardation plate functions also as a transparent protective film.

Examples of the retardation plate include a birefringence film obtained by drawing a polymer material monoaxially or biaxially, an alignment film made of a liquid crystal polymer, and a product in which an alignment layer made of a liquid crystal polymer is supported on a film. The thickness of the retardation plate is not particularly limited, and is generally from about 20 to about 150 μm.

Examples of the polymer material include polyvinyl alcohol, polyvinyl butyral, polymethyl vinyl ether, polyhydroxyethyl acrylate, hydroxyethylcellulose, hydroxypropylcellulose, methylcellulose, polycarbonate, polyarylate, polysulfone, polyethylene terephthalate, polyethylene naphthalate, polyethersulfone, polyphenylene sulfide, polyphenylene oxide, polyallylsulfone, polyamide, polyimide, polyolefin, polyvinyl chloride, cellulose resin, and cyclic polyolefin resin (norbornene resin); and binary, ternary and other various copolymers, graft copolymers, and blends of two or more of these polymers. These polymer materials may be made into aligned products (drawn films) by drawing, or some other processing.

The liquid crystal polymer may be of various types, such as amain chain type and a side chain type in which a conjugated linear atomic group (mesogen) for giving a liquid alignment is introduced into a main chain and a side chain of a polymer, respectively. Specific examples of the main chain type liquid crystal polymer include a nematic alignment polyester liquid crystal polymer, a discotic polymer and a cholesteric polymer each having a structure in which a mesogen group is bonded via a spacer moiety for imparting flexibility. A specific example of the side chain type liquid crystal polymer is one having, as a main chain skeleton, polysiloxane, polyacrylate, polymethacrylate or polymalonate, and having, as a side chain, a mesogen moiety made of a para-substituted cyclic compound unit capable of giving nematic alignment via a spacer moiety made of a conjugated atomic group. These liquid crystal polymers are each obtained, for example, by developing a solution of the liquid crystal polymer onto an alignment treated surface of a product obtained by subjecting a surface of a thin film made of, for example, polyimide or polyvinyl alcohol, formed on a glass plate to rubbing treatment; or a product in which silicon oxide is obliquely evaporated onto the same surface; and then treating the workpiece thermally.

The retardation plate may be one having an appropriate retardation corresponding to a use purpose thereof, for example, one for compensating for coloration or a viewing angle change on the basis of the birefringence of various wavelength plates or the liquid crystal layer. The retardation plate may be a product in which two or more retardation plates are laminated onto each other so as to be controlled in retardation and other optical properties.

The retardation plate is selected from those satisfying relationships of nx=ny>nz, nx>ny>nz, nx>ny=nz, nx>nz>ny, nz=nx>ny, nz>nx>ny, and nz>nx=ny in accordance with a use purpose thereof that may be of various types, and then used. The relationship “ny=nz” denotes not only a case where ny is completely equal to nz but also a case where ny is substantially equal to nz.

In the case of, for example, a retardation plate satisfying “nx>ny>nz”, it is preferred to use a retardation plate having an in-plane retardation of 40 to 100 nm, a thickness-direction retardation of 100 to 320 nm and an Nz coefficient of 1.8 to 4.5. In the case of, for example, a retardation plate satisfying “nx>ny=nz” (positive A plate), it is preferred to use a retardation plate having an in-plane retardation of 100 to 200 nm. In the case of, for example, a retardation plate satisfying “nz=nx>ny” (negative A plate), it is preferred to use a retardation plate having an in-plane retardation of 100 to 200 nm. In the case of, for example, a retardation plate satisfying “nx>nz>ny”, it is preferred to use a retardation plate having an in-plane retardation of 150 to 300 nm and an Nz coefficient of more than 0, and 0.7 or less. As described above, a retardation plate satisfying nx=ny>nz, nz>nx>ny, or nz>nx=ny may be used.

The transparent protective film may be appropriately selected in accordance with a liquid crystal display device in which the film is used. In the case of, for example, a device in a VA (vertical alignment) mode, which may be an MVA or PVA mode, it is desired that a transparent protective film on at least one side (cell side) of its polarizing plate has a retardation. Specifically, the retardation desirably satisfies the following: Re=0 to 240 nm, and Rth=0 to 500 nm. About the three dimensional refractive indexes thereof, it is desired to satisfy nx>ny=nz, nx>ny>nz, nx>nz>ny, or nx=ny>nz (a positive A plate, a biaxial film or a negative C plate). In the VA mode device, it is preferred to use a combination of a positive A plate with a negative C plate, or a biaxial film alone. In the case of using polarizing plates over and under its liquid crystal cell, respectively, respective transparent protective films over and under the liquid crystal cell may each have a retardation, or either one of the protective films may have a retardation.

In the case of, for example, a device in an IPS (in-plane switching) mode, which may be an FFS mode, any polarizing plate may be used wherein a transparent protective film on one side of the film may or may not have a retardation. For example, when the transparent protective film has no retardation, it is desired that transparent protective films, which include the protective film described just above, over and under the liquid crystal cell (cell side) each have no retardation. When the transparent protective film has a retardation, it is desired that transparent protective films over and under the liquid crystal cell each have a retardation, or either one of these films has a retardation (for example, a case where the upper transparent protective film is a biaxial film satisfying the relationship “nx>nz>ny” and the lower transparent protective film has no retardation, or a case where the upper transparent protective film is a positive A plate and the lower transparent protective film is a positive C plate). When the transparent protective film has a retardation, the retardation desirably satisfies the following: Re=−500 to 500 nm, and Rth=−500 to 500 nm. About the three dimensional refractive indexes thereof, it is desired to satisfy nx>ny=nz, nx>nz>ny, nz>nx=ny, or nz>nx>ny (a positive A plate, a biaxial film or a positive C plate).

When the above-mentioned film, which has a retardation, is bonded to a transparent protective film having no retardation, the above-mentioned function can be given thereto.

The above-mentioned transparent protective films may be subjected to surface-modifying treatment, before a pressure-sensitive adhesive is applied thereto, to improve the adhesion thereof onto a polarizer. Specific examples of the treatment include corona treatment, plasma treatment, flame treatment, ozone treatment, primer treatment, glow treatment, saponifying treatment, and treatment by a coupling agent. An antistatic layer may be appropriately formed thereon.

A hard coat layer or a treatment for reflection reduction, sticking prevention, diffusion or anti-glaring may be applied onto the surface of the transparent protective film to which no polarizer is bonded.

The hard coat layer is a layer for preventing a scratch in the front surface of the polarizing plate, and may be formed, for example, in a manner of applying, onto the front surface of the transparent protective film, a cured coat film that is made of an appropriate ultraviolet curable resin, such as an acrylic or silicone resin, and is excellent in hardness, slipping property and others. The reflection reduction treatment is conducted so as to reduce reflection of external light on the front surface of the polarizing plate, and may be attained by forming a reflection reduction film according to a conventional method. The sticking prevention treatment may be conducted so as to prevent the transparent protective film from adhering closely to an adjacent layer (such as a diffusion plate on the back light side of a liquid crystal display device).

The anti-glaring treatment is conducted, for example, in order to prevent a matter that external light is reflected on the front surface of the polarizing plate so that light transmitted through the polarizing plate is hindered from being viewed. This treatment can be attained by imparting a structure of fine irregularities to the front surface of the transparent protective film in an appropriate manner, for example, a surface-roughening manner such as a sandblasting manner or an embossing manner, or a manner of blending transparent fine particles. Fine particles incorporated into the front-surface fine-irregularity-structure to form this structure may be, for example, transparent fine particles, such as inorganic fine particles that have an average particle diameter of 0.5 to 20 μm, made of, for example, silica, alumina, titania, zirconia, tin oxide, indium oxide, cadmium oxide or antimony oxide, and may have electroconductivity, or organic fine particles made of, for example, a crosslinked or uncrosslinked polymer. When the front-surface fine-irregularity-structure is formed, the amount of the fine particles used is generally from about 2 to about 70 parts by weight, preferably from 5 to 50 parts by weight for 100 parts by weight of a transparent resin that forms the front-surface fine-irregularity-structure. The antiglare layer may be a layer functioning also as a diffusion layer for enlarging the viewing angle and the like (for example, a viewing angle enlarging function) by causing light transmitted through the polarizing plate to diffuse.

The above-mentioned reflection reduction layer, sticking prevention layer, diffusion layer and antiglare layer, and the like may be provided onto the transparent protective film itself, or may be provided as an optical layer in the form of a member separated from the transparent protective film.

For the treatment for bonding the polarizer and the transparent protective film onto each other, an adhesive is used. Examples of the adhesive include isocyanate adhesives, polyvinyl alcohol adhesives, gelatin adhesives, vinyl latex adhesives, and water-affinitive polyesters. The adhesive is usually used in the form of a solution of the agent in water, and usually contains 0.5 to 60% by weight of a solid content. Besides the above, examples of the adhesive for the polarizer and the transparent protective film include ultraviolet curable adhesives, and electron beam curable adhesives. The electron beam curable adhesives for a polarizing plate show a tackiness suitable for the above-mentioned various transparent protective films. A metal compound filler may be incorporated into the adhesive used in the present invention.

The optical film may be an optical layer that may be used to form, for example, a liquid crystal display device. Examples thereof include reflectors, anti-transmission plates, retardation plates, which may be, for example, half and quarter wavelength plates, viewing angle compensation films, brightness enhancement films, and surface treatment films. These may be used alone as an optical film, or may be used in a form that one or more thereof are laminated onto the polarizing plate when practically used.

A surface treatment film may be provided by being bonded onto a front plate. Examples of the surface treatment film include a hard coat film for imparting scratch resistance to a surface, an antiglare treatment film for preventing an undesired image from being protected onto an image display device, and reflection reduction films such as an antireflective film and a low reflective film. The front plate is provided by being bonded onto the front surface of an image display device, such as a liquid crystal display device, an organic EL display device, a CRT or a PDP, to protect the image display device, impart a high-class impression thereto, and discriminate the device from others by a design thereof. The front plate may be also used as a supporter for a λ/4 plate in a 3D-TV. For example, in a liquid crystal display device, a front plate is located over its polarizing plate at the viewing-side of the device. When the pressure-sensitive adhesive layer in the present invention is used, a glass substrate as the front plate produces advantageous effects; besides, a plastic substrate, such as a polycarbonate substrate or a polymethyl methacrylate substrate, produces the same advantageous effects.

The optical film in which the above-mentioned optical layers are laminated on a polarizing plate may be formed by a method of laminating the optical layers successively and individually in a process for producing, for example, a liquid crystal display device. However, the optical film obtained by laminating the optical layers beforehand is excellent in quality stability, fabricating workability and the like to produce an advantage of giving an improved liquid crystal display device and improving the productivity thereof. For laminating, an appropriate adhesive means, such as a pressure-sensitive adhesive layer, may be used. When the polarizing plate is bonded to the optical layers, an optical axis of these members may be set to an appropriate layout angle in accordance with, for example, a target retardation property.

The pressure-sensitive adhesive-type optical film of the present invention may be preferably used for formation of various image display devices such as a liquid crystal display device, and the like. The liquid crystal display device may be formed according to the prior art. Specifically, a liquid crystal display device is generally formed, for example, by fabricating appropriately a display panel such as a liquid crystal cell, a pressure-sensitive adhesive layer-carrying optical film, an optional lighting system and other constituent members, and integrating a driving circuit into the workpiece; in the present invention, a liquid crystal display device is formed according to such a conventional method without especial limitation, except that the pressure-sensitive adhesive layer-carrying optical film according to the present invention is used. Its liquid crystal cell may be a cell in any mode, such as a TN, STN, π, VA, or IPS mode.

The present invention is used to make it possible to form an appropriate liquid crystal display device, such as a display device in which the pressure-sensitive adhesive-carrying optical film is arranged on one or both sides of a display panel such as a liquid crystal cell, or a display device in which a backlight or a reflector is used as a lighting system. In this case, the optical films according to the present invention may be provided at one or both sides of the display panel such as the liquid crystal cell. When the optical films are located at both the sides, the films may be the same or different. Further, when the liquid crystal display device is formed, appropriate members such as a diffusion plate, an antiglare layer, a reflection reduction film, a protective plate, a prism array, a lens array sheet, a light diffusion plate, and a backlight may be arranged at any appropriate positions as one layer or two layers or more.

The following will describe an organic electroluminescence device (organic EL display device: OLED). Generally, in an organic EL display device, a transparent electrode, an organic luminous layer and a metal electrode are successively laminated onto a transparent substrate to form a luminous body (organic electroluminescence body). The organic luminous layer is a laminate body composed of various organic thin films. As the structure of this layer, structures having a combination that may be of various types are known, for example, a laminate body composed of a hole injection layer made of, for example, a triphenylamine derivative, and a luminous layer made of a fluorescent organic solid such as anthracene, a laminate body composed of such a luminous layer and an electron injection layer made of, for example, a perylene derivative, or a laminate body composed of a hole injection layer, a luminous layer and an electron injection layer as described herein.

In an organic EL display device, by applying a voltage to its transparent electrode and its metal electrode across them, holes and electrons are injected into the organic luminous layer, and the holes and electrons are recombined to generate an energy. The energy excites the fluorescent substance. When the excited fluorescent substance is returned to a ground state thereof, light is radiated. By this principle, light is emitted. The mechanism of the recombination in the middle of this process is equivalent to that of ordinary diodes. As can be expected also from this matter, the electric current and the luminescence intensity show an intense non-linearity, with rectification, relative to an applied voltage.

In an organic EL display device, at least one of its electrodes needs to be transparent to take out luminescence from the organic luminous layer. Usually, its transparent electrode made of a transparent electroconductor such as indium tin oxide (ITO) is used as a positive electrode. In order to make the injection of electrons easy to raise the luminescence efficiency, it is important to use a substance small in working function for a negative electrode. Usually, an electrode made of a metal, such as Mg—Ag or Al—Li, is used.

In an organic EL display device having such a structure, its organic luminous layer is formed with a very thin film having a thickness of about 10 nm. Thus, like its transparent electrode, the organic luminous layer also transmits light substantially completely. As a result, when no light is emitted, light radiated into the device from a surface of its transparent substrate, transmitted through the transparent electrode and the organic luminous layer and then reflected on its metal electrode is again directed to the surface of the transparent substrate. Accordingly, when the organic EL display device is viewed from the outside, the display surface of the device looks a mirror plane.

In an organic-electroluminescent-body-containing organic EL display device having a transparent electrode on the front surface side of its organic luminous layer, which emits light when a voltage is applied to the device, and further having a metal electrode on the rear surface side of the organic luminous layer, a polarizing plate may be provided on the front surface side of the transparent electrode and further a retardation plate may be interposed between the transparent electrode and the polarizing plate.

Since the retardation plate and the polarizing plate have an action of polarizing light radiated thereinto from the outside and then reflected on the metal electrode, these members have an effect that the mirror plane of the metal electrode is caused not to be viewed from the outside by the polarizing effect. In particular, in the case of rendering the retardation plate a quarter wavelength plate and adjusting the angle between the respective polarizing directions of the polarizing plate and the retardation plate to π/4, the mirror plane of the metal electrode can be completely shielded.

In short, about external light radiated into this organic EL display device, only its linearly polarized light component is transmitted by effect of the polarizing plate. This linearly polarized light ray is generally turned to an elliptically polarized light ray by the retardation plate. However, particularly, when the retardation plate is a quarter wavelength plate and further the angle between the respective polarizing directions of the polarizing plate and the retardation plate is π/4, the light ray is turned to a circularly polarized light ray.

This circularly polarized light ray is transmitted through the transparent substrate, the transparent electrode, and the organic thin film, reflected on the metal electrode, and again transmitted through the organic thin film, the transparent electrode and the transparent substrate to be again turned to a linearly polarized light ray through the retardation plate. This linearly polarized light ray is perpendicular to the polarizing direction of the polarizing plate so as not to be transmissible through the polarizing plate. As a result, the mirror plane of the metal electrode can be completely shielded.

### EXAMPLES

Hereinafter, the present invention will be more specifically described with reference to examples, which however are not intended to limit the present invention. Unless otherwise stated, “parts” and “%” in each example are all by weight.

### Example 1

In Example 1, an aqueous dispersion-type acryl-based pressure-sensitive adhesive was used as a pressure-sensitive adhesive coating liquid. The aqueous dispersion-type acryl-based pressure-sensitive adhesive was prepared as follows. To a vessel were added 55,554 parts of butyl acrylate, 2,776 parts of acrylic acid, 1,665 parts of mono[poly(propylene oxide)methacrylate]phosphate ester (5.0 in average degree of polymerization of propylene oxide), and 5 parts of 3-methacryloyloxypropyl-triethoxysilane (KBM-503 manufactured by Shin-Etsu Chemical Co., Ltd.) as starting materials, and mixed to form a monomer mixture. Subsequently, 1,300 parts of AQUALON HS-10 (manufactured by DAI-ICHI KOGYO SEIYAKU CO., LTD.) as a reactive emulsifier and 38,700 parts of ion-exchanged water were added to 60,000 parts of the prepared monomer mixture. The resulting mixture was stirred at 7,000 rpm for 10 minutes using a homogenizer (manufactured by PRIMIX Corporation) to form a monomer emulsion. Subsequently, 20,000 parts of the monomer emulsion prepared as described above and 35,000 parts of ion-exchanged water were added to a reaction vessel equipped with a condenser tube, a nitrogen-introducing tube, a thermometer, a dropping funnel, and a stirring blade. Subsequently, after the air in the reaction vessel was sufficiently replaced by nitrogen gas, 10 parts of ammonium persulfate was added to the reaction vessel, and the mixture was subjected to polymerization at 60° C. for 1 hour. Subsequently, 80,000 parts of the remaining monomer emulsion was added dropwise to the reaction vessel over 3 hours, and then the mixture was subjected to polymerization for 3 hours. Subsequently, the mixture was further subjected to polymerization at 65° C. for 5 hours while the air was replaced by nitrogen gas, so that an aqueous dispersion-type pressure-sensitive adhesive solution with a solid concentration of 45% was obtained. Subsequently, after the emulsion solution was cooled to room temperature, 30 parts of 10% ammonia water was added to the emulsion solution. Distilled water was further added to the emulsion solution so that its solid concentration was adjusted to 39%. The viscosity of the resulting liquid was 2,000 mPa·s as measured using a Brookfield type viscometer (manufactured by Toki Sangyo Co., Ltd) at 23° C. and a rotor speed of 20 rpm.

The resulting aqueous dispersion-type acryl-based pressure-sensitive adhesive was introduced into a tank. The pressure-sensitive adhesive coating liquid comprising the aqueous dispersion-type acryl-based pressure-sensitive adhesive was filtered using a coating liquid supplying apparatus including a pump for feeding the liquid (feed rate: 2 L/minute), a filtration unit including a depth type filter (6 parts each 30 inches in size) having a filtration accuracy of 1 μm and also having a filtration accuracy gradient, and a transport unit for transporting the coating liquid, in which the initial differential pressure of the filtration unit was set at 40 kPa (filtration step).

The numbers of air bubbles and contaminants in the pressure-sensitive adhesive coating liquid were evaluated using a particle counter before and after the coating liquid passed through the filtration unit (depth type filter). The particle counter used measures the sizes and numbers of air bubbles and contaminants in the pressure-sensitive adhesive coating liquid by detecting the amount of attenuation of laser light with a photo-detector based on the principle that air bubbles and/or contaminants in the pressure-sensitive adhesive coating liquid attenuate laser light when laser light is applied to the pressure-sensitive adhesive coating liquid passing through a certain region. The evaluation method will be described in detail below.

(Method for Evaluation of the Numbers of Air Bubbles and Contaminants)

To evaluate the numbers of air bubbles and contaminants in the coating liquid, air bubbles and contaminants 5 to 100 μm in size were counted using a light-blocking particle counter manufactured by Particle Measuring Systems, Inc. The coating liquid was sampled and evaluated before and after it was filtered. To evaluate the life (service life) of the filter, the filtrate was also sampled after the filter were continuously used for 10 hours, and subjected to the measurement with the particle counter. The results of the measurement were expressed as the numbers of air bubbles and contaminants per unit weight (/g). The total of the measured numbers of air bubbles and contaminants of 5 to 100 μm was calculated, and the removal efficiency of formula (I) below was calculated from the numbers of air bubbles and contaminants measured before and after the filtration, and used for evaluation. Table 1 shows the results of the evaluation of each example and each comparative example.

[Removal efficiency]=([the number of air bubbles and contaminants after the filtration]/[the number of air bubbles and contaminants before the filtration])×100 (1)

### Examples 2 to 9

The pressure-sensitive adhesive coating liquid comprising the aqueous dispersion-type acryl-based pressure-sensitive adhesive was filtered using the same method as in Example 1 (filtration step), except that the filtration accuracy, the presence or absence of the filtration accuracy gradient, and the differential pressure were changed as shown in Table 1.

### Comparative Example 1

The pressure-sensitive adhesive coating liquid comprising the aqueous dispersion-type acryl-based pressure-sensitive adhesive was filtered using the same method as in Example 1 (filtration step), except that a pleated type filter was used instead of the depth type filter.

### Comparative Examples 2 to 4

The pressure-sensitive adhesive coating liquid comprising the aqueous dispersion-type acryl-based pressure-sensitive adhesive was filtered using the same method as in Example 1 (filtration step), except that the filtration accuracy, the presence or absence of the filtration accuracy gradient, and the differential pressure were changed as shown in Table 1.

TABLE 1

| | | Presence or | | | | | | |
|---|---|---|---|---|---|---|---|---|
| | | absence of | | | | Efficiency (%) of | Differential | Removal |
| | | filtration | Filtration | Differential | | removal of air bubbles | pressure | efficiency |
| | | accuracy | accuracy | pressure | Viscosity | and/or contaminants | (kPa) after | (%) after |
| | Filter type | gradient | (μm) | (kPa) | (mPa · s) | of less than 100 μm | 10 hours | 10 hours |
| Example 1 | Depth type | Present | 1 | 40 | 2000 | 99 | 140 | 90 |
| Example 2 | Depth type | Present | 5 | 40 | 2000 | 99 | 60 | 99 |
| Example 3 | Depth type | Present | 10 | 40 | 2000 | 97 | 52 | 97 |
| Example 4 | Depth type | Present | 20 | 40 | 2000 | 92 | 45 | 93 |
| Example 5 | Depth type | Present | 5 | 100 | 2000 | 99 | 130 | 97 |
| Example 6 | Depth type | Present | 5 | 130 | 2000 | 97 | 150 | 91 |
| Example 7 | Depth type | Present | 5 | 40 | 5 | 99 | 60 | 99 |
| Example 8 | Depth type | Present | 5 | 40 | 50000 | 99 | 60 | 99 |
| Example 9 | Depth type | Absent | 10 | 40 | 2000 | 95 | 78 | 93 |
| Comparative | Pleated type | Present | 10 | 40 | 2000 | 64 | 58 | 58 |
| Example 1 | | | | | | | | |
| Comparative | Depth type | Present | 5 | 160 | 2000 | 27 | 179 | 21 |
| Example 2 | | | | | | | | |
| Comparative | Depth type | Present | 25 | 40 | 2000 | 82 | 42 | 82 |
| Example 3 | | | | | | | | |
| Comparative | Depth type | Present | 0.5 | 40 | 2000 | 99 | 170 | 20 |
| Example 4 | | | | | | | | |

The results in Table 1 show that in each of Examples 1 to 9, the filtration step significantly reduced the numbers of air bubbles and contaminants of 100 μm or less in the pressure-sensitive adhesive coating liquid and did not decrease in efficiency of removal of air bubbles and contaminants even after the filter was continuously used for 10 hours.

On the other hand, it is apparent that the efficiency of removal of air bubbles and contaminants decreased in Comparative Example 1 where a pleated type filter was used, in Comparative Example 2 where the differential pressure was relatively high, and in Comparative Example 3 where the filtration accuracy value was relatively large.

It is also apparent that in Comparative Example 4 where the filtration accuracy value was relatively small, the initial efficiency of removal of air bubbles and contaminants was good, but the differential pressure increased with time, and the efficiency of removal of air bubbles and contaminants decreased with time. Thus, it has been found that there is an optimal range (1 to 20 μm) of filtration accuracy when air bubbles and contaminants are removed, by filtration with a depth type filter, from a pressure-sensitive adhesive coating liquid containing an aqueous dispersion-type acryl-based pressure-sensitive adhesive.

(Formation of Pressure-Sensitive Adhesive Layer)

The pressure-sensitive adhesive coating liquid obtained after the filtration step in each of Examples 1 to 9 and

Comparative Examples 1 to 4 was applied with a die coater to the release-treated surface of a separator made of polyethylene terephthalate (38 μm in thickness) so that a coating with a dry thickness of 25 μm could be formed, and the coating was dried at 100° C. for 150 seconds to form a pressure-sensitive adhesive layer.

(Air Bubbles and/or Contaminants in the Pressure-Sensitive Adhesive Layer)

The number and size of air bubbles and/or contaminants in the surface (1 m² area) of the resulting pressure-sensitive adhesive layer were measured visually and using an optical microscope. Table 2 shows the number (/m²) of air bubbles and/or contaminants with a maximum length of 20 μm or more. In Table 2, “Number (/m²) of air bubbles and/or contaminants of 20 μm or more after 10 hours” means the number (/m) of air bubbles and/or contaminants of 20 μm or more measured in the surface of the pressure-sensitive adhesive layer formed using the pressure-sensitive adhesive coating liquid obtained by filtration after the filter was continuously used for 10 hours for the purpose of evaluating the life (service life) of the filter.

TABLE 2

| | Number (/m²) | Number (/m²) |
|---|---|---|
| | of air bubbles and/or | of air bubbles and/or |
| | contaminants of | contaminants of 20 μm |
| | 20 μm or more | or more after 10 hours |
| Example 1 | 0 | 8 |
| Example 2 | 0 | 0 |
| Example 3 | 2 | 1 |
| Example 4 | 7 | 5 |
| Example 5 | 0 | 4 |
| Example 6 | 0 | 8 |
| Example 7 | 0 | 0 |
| Example 8 | 1 | 1 |
| Example 9 | 3 | 5 |
| Comparative | >100 | >100 |
| Example 1 | | |
| Comparative | >100 | >100 |
| Example 2 | | |
| Comparative | 24 | 28 |
| Example 3 | | |
| Comparative | 1 | >100 |
| Example 4 | | |

The results in Table 2 show that the pressure-sensitive adhesive layer formed using the pressure-sensitive adhesive coating liquid obtained after the filtration step in each of Examples 1 to 9 contained a significantly reduced number of air bubbles (detected as contaminants) and contaminants. Thus, it is apparent that a pressure-sensitive adhesive-type optical film-manufacturing method including the filtration step of each of Examples 1 to 9 also makes it possible to form a pressure-sensitive adhesive layer with almost no air bubbles or contaminants and to manufacture a pressure-sensitive adhesive-type optical film with a reduced number of appearance defects caused by air bubbles and contaminants.

On the other hand, it is apparent that the pressure-sensitive adhesive layer formed using the pressure-sensitive adhesive coating liquid obtained after the filtration step in each of Comparative Examples 1 to 3 contains a relatively large number of air bubbles (detected as contaminants) and contaminants, so that a pressure-sensitive adhesive-type optical film containing a relatively large number of appearance defects caused by air bubbles and contaminants can be finally obtained.

It is also apparent that the pressure-sensitive adhesive layer formed using the pressure-sensitive adhesive coating liquid obtained after the filtration step in Comparative Example 4 gradually increases in number of air bubbles and contaminants, which can form appearance defects, because in the filtration step, the differential pressure increases with time and the efficiency of removal of air bubbles and contaminants decreases with time.

1. A method for manufacturing a pressure-sensitive adhesive layer for use on an optical film, the method comprising: a filtration step comprising filtering a pressure-sensitive adhesive coating liquid under a differential pressure of more than 0 kPa and not more than 150 kPa using a depth type filter having a filtration accuracy of 1 to 20 μm, wherein the pressure-sensitive adhesive coating liquid contains an aqueous dispersion-type pressure-sensitive adhesive; and an application and drying step comprising applying the filtered pressure-sensitive adhesive coating liquid and then drying the coating liquid.

2. The method according to claim 1, wherein the depth type filter has a filtration accuracy gradient.

3. A pressure-sensitive adhesive layer for use on an optical film, comprising a product manufactured by the method according to claim 1.

4. The pressure-sensitive adhesive layer according to claim 3, which contains no air bubble and/or contaminant with a maximum length of more than 100 μm and has a surface in which the number of air bubbles and/or contaminants with a maximum length of 20 μm or more is 10 per m² or less.

5. A method for manufacturing a pressure-sensitive adhesive-type optical film comprising an optical film and a pressure-sensitive adhesive layer placed on at least one side of the optical film,
the method comprising the step of forming the pressure-sensitive adhesive layer, which comprises a filtration step comprising filtering a pressure-sensitive adhesive coating liquid as a raw material for the pressure-sensitive adhesive layer under a differential pressure of more than 0 kPa and not more than 150 kPa using a depth type filter, wherein
the pressure-sensitive adhesive coating liquid contains an aqueous dispersion-type pressure-sensitive adhesive, and
the depth type filter has a filtration accuracy of 1 μm to 20 μm.

6. The method according to claim 5, wherein the depth type filter has a filtration accuracy gradient.

7. The method according to claim 5, further comprising: an application and drying step comprising applying the pressure-sensitive adhesive coating liquid to a flexible support (web) after the filtration step and drying the coating liquid to form a pressure-sensitive adhesive layer-bearing flexible support (web); and a transfer step comprising transferring the pressure-sensitive adhesive layer from the pressure-sensitive adhesive layer-bearing flexible support (web) onto the optical film.

8. The method according to claim 5, further comprising an application and drying step comprising applying the pressure-sensitive adhesive coating liquid onto the optical film after the filtration step and then drying the coating liquid.

9. A pressure-sensitive adhesive-type optical film, comprising a product manufactured by the method according to claim 5.

10. An image display device comprising at least one piece of the pressure-sensitive adhesive-type optical film according to claim 9.

11. A coating liquid supplying apparatus for supplying a pressure-sensitive adhesive coating liquid as a raw material for a pressure-sensitive adhesive layer for forming a pressure-sensitive adhesive-type optical film,
the apparatus comprising at least a pump for feeding the pressure-sensitive adhesive coating liquid, a filtration unit for removing air bubbles from the pressure-sensitive adhesive coating liquid, and a transport unit for transporting the pressure-sensitive adhesive coating liquid, wherein
the filtration unit comprises a depth type filter having a filtration accuracy of 1 μm to 20 μm and has the function of filtering the coating liquid under a differential pressure of more than 0 kPa and not more than 150 kPa.

12. The coating liquid supplying apparatus according to claim 11, wherein the depth type filter has a filtration accuracy gradient.
